(19) United States
(12) Patent Application Publication
(10) Pub. No.: US 2006/0168331 A1
(43) Pub. Date: Jul. 27, 2006

(54) Intelligent messaging application programming interface

(75) Inventors: J. Barry Thompson, New York, NY (US); Kul Singh, New York, NY (US); Pierre Fraval, New York, NY (US)

Correspondence Address: BROWN RAYSMAN MILLSTEIN FELDER & STEINER LLP, 303 TWIN DOLPHIN DRIVE, SUITE 600, REDWOOD SHORES, CA, 94065, US

(73) Assignee: Terevela, Inc., New York, NY (US)

(21) Appl. No.: 11/317,280

(22) Filed: Dec. 23, 2005

Related U.S. Application Data
(60) Provisional application No. 60/641,988, filed on Jan. 6, 2005.
(60) Provisional application No. 60/688,983, filed on Jun. 8, 2005.

(51) Int. Cl. G06F 15/173

(52) U.S. Cl. 709/238

(57) ABSTRACT

Message publish/subscribe systems are required to process high message volumes with reduced latency and performance bottlenecks. The intelligent messaging application programming interface (API) introduced by the present invention is designed for high-volume, low-latency messaging. The API is part of a publish/subscribe middleware system. With the API, this system operates to, among other things, monitor system performance, including latency, in real time, employ topic-based and channel-based message communications, and dynamically optimize system interconnect configurations and message transmission protocols.

### REFERENCE TO EARLIER-FILED APPLICATIONS

This application claims the benefit of and incorporates by reference U.S. Provisional Application Ser. No. 60/641,988, filed Jan. 6, 2005, entitled “Event Router System and Method” and U.S. Provisional Application Ser. No. 60/688,983, filed Jun. 8, 2005, entitled “Hybrid Feed Handlers And Latency Measurement.”

This application is related to and incorporates by reference U.S. patent application Ser. No. ______ (Attorney Docket No. 50003-0004), Filed Dec. 23, 2005, entitled “End-To-End Publish/Subscribe Middleware Architecture.”

### FIELD OF THE INVENTION

The present invention relates to data messaging middleware architecture and more particularly to application programming interface in messaging systems with a publish and subscribe (hereafter “publish/subscribe”) middleware architecture.

### BACKGROUND

The increasing level of performance required by data messaging infrastructures provides a compelling rationale for advances in networking infrastructure and protocols. Fundamentally, data distribution involves various sources and destinations of data, as well as various types of interconnect architectures and modes of communications between the data sources and destinations. Examples of existing data messaging architectures include hub-and-spoke, peer-to-peer and store-and-forward.

With the hub-and-spoke system configuration, all communications are transported through the hub, often creating performance bottlenecks when processing high volumes. Therefore, this messaging system architecture produces latency. One way to work around this bottleneck is to deploy more servers and distribute the network load across these different servers. However, such architecture presents scalability and operational problems. By comparison to a system with the hub-and-spoke configuration, a system with a peer-to-peer configuration creates unnecessary stress on the applications to process and filter data and is only as fast as its slowest consumer or node. Then, with a store-and-forward system configuration, in order to provide persistence, the system stores the data before forwarding it to the next node in the path. The storage operation is usually done by indexing and writing the messages to disk, which potentially creates performance bottlenecks. Furthermore, when message volumes increase, the indexing and writing tasks can be even slower and thus, can introduce additional latency.

Existing data messaging architectures share a number of deficiencies. One common deficiency is that data messaging in existing relies on software that resides at the application level. This implies that the messaging infrastructure experiences OS (operating system) queuing and network I/O (input/output), which potentially create performance bottlenecks. Another common deficiency is that existing architectures use data transport protocols statically rather than dynamically even if other protocols might be more suitable under the circumstances. A few examples of common protocols include routable multicast, broadcast or unicast. Indeed, the application programming interface (API) in existing architectures is not designed to switch between transport protocols in real time.

Also, network configuration decisions are usually made at deployment time and are usually defined to optimize one set of network and messaging conditions under specific assumptions. The limitations associated with static (fixed) configuration preclude real time dynamic network reconfiguration. In other words, existing architectures are configured for a specific transport protocol which is not always suitable for all network data transport load conditions and therefore existing architectures are often incapable of dealing, in real-time, with changes or increased load capacity requirements.

Furthermore, when data messaging is targeted for particular recipients or groups of recipients, existing messaging architectures use routable multicast for transporting data across networks. However, in a system set up for multicast there is a limitation on the number of multicast groups that can be used to distribute the data and, as a result, the messaging system ends up sending data to destinations which are not subscribed to it (i.e., consumers which are not subscribers of this particular data). This increases consumers' data processing load and discard rate due to data filtering. Then, consumers that become overloaded for any reason and cannot keep up with the flow of data eventually drop incoming data and later asks for retransmissions. Retransmissions affect the entire system in that all consumers receive the repeat transmissions and all of them re-process the incoming data. Therefore, retransmissions can cause multicast storms and eventually bring the entire networked system down.

When the system is set up for unicast messaging as a way to reduce the discard rate, the messaging system may experience bandwidth saturation because of data duplication. For instance, if more than one consumer subscribes to a given topic of interest, the messaging system has to deliver the data to each subscriber, and in fact it sends a different copy of this data to each subscriber. And, although this solves the problem of consumers filtering out non-subscribed data, unicast transmission is non-scalable and thus not adaptable to substantially large groups of consumers subscribing to a particular data or to a significant overlap in consumption patterns.

Additionally, in the path between publishers and subscribers messages are propagated in hops between applications with each hop introducing application and operating system (OS) latency. Therefore, the overall end-to-end latency increases as the number of hops grows. Also, when routing messages from publishers to subscribers the message throughput along the path is limited by the slowest node in the path, and there is no way in existing systems to implement end-to-end messaging flow control to overcome this limitation.

One more common deficiency of existing architectures is their slow and often high number of protocol transformations. The reason for this is the IT (information technology) band-aid strategy in the Enterprise Application Integration (EAI) domain, where more and more new technologies are integrated with legacy systems.

Hence, there is a need to improve data messaging systems performance in a number of areas. Examples where performance might need improvement are speed, resource allocation, latency, and the like.

### SUMMARY OF THE INVENTION

The present invention is based, in part, on the foregoing observations and on the idea that such deficiencies can be addressed with better results using a different approach. These observations gave rise to the end-to-end message publish/subscribe middleware architecture for high-volume and low-latency messaging and particularly an intelligent messaging application programming interface (API). So therefore, for communications with applications a data distribution system with an end-to-end message publish/subscribe middleware architecture that includes an intelligent messaging API in accordance with the principles of the present invention can advantageously route significantly higher message volumes and with significantly lower latency. To accomplish this, the present invention contemplates, for instance, improving communications between APIs and messaging appliances through reliable, highly-available, session-based fault tolerant design and by introducing various combinations of late schema binding, partial publishing, protocol optimization, real-time channel optimization, value-added calculations definition language, intelligent messaging network interface hardware, DMA (direct memory access) for applications, system performance monitoring, message flow control, message transport logic with temporary caching and value-added message processing.

Thus, in accordance with the purpose of the invention as shown and broadly described herein one exemplary API for communications between applications and a publish/subscribe middleware system includes a communication engine, one or more stubs, and an inter-process communications bus (which we refer to simply as bus). In one embodiment, the communication engine might be implemented as a daemon process when, for instance, more than one application leverage a single communication engine to receive and send messages. In another embodiment, the communication engine might be compiled into an application along with the stub in order to eliminate the extra daemon hop. In such instance, a bus between the communication engine and the stub would be defined as an intra-process communication bus.

In this embodiment, the communication engine is configured to function as a gateway for communications between the applications and the publish/subscribe middleware system. The communication engine is operative, transparently to the applications, for using a dynamically selected message transport protocol to thereby provide protocol optimization and for monitoring and dynamically controlling, in real time, transport channel resources and flow. The one or more stubs are used for communications between the applications and the communication engine. In turn, the bus is for communications between the one or more stubs and the communication engine.

In further accordance with the purpose of the present invention, a second example of the API also includes a communication engine, one or more stubs and a bus. The communication engine in this embodiment is built with logical layers including a message layer and a message transport layer, wherein the message layer includes an application delivery routing engine, an administrative message layer and a message routing engine and wherein the message transport layer includes a channel management portion for controlling transport paths of messages handled by the message layer.

The foregoing embodiments are two of the examples for implementing the API and other examples will become apparent from the drawings and the description that follows. In sum, these and other features, aspects and advantages of the present invention will become better understood from the description herein, appended claims, and accompanying drawings as hereafter described.

### BRIEF DESCRIPTION OF THE DRAWINGS

The accompanying drawings which are incorporated in and constitute a part of this specification illustrate various aspects of the invention and together with the description, serve to explain its principles. Wherever convenient, the same reference numbers will be used throughout the drawings to refer to the same or like elements.

FIG. 1 illustrates an end-to-end middleware architecture in accordance with the principles of the present invention.

FIG. 1a is a diagram illustrating an overlay network.

FIG. 2 is a diagram of illustrating an enterprise infrastructure implemented with an end-to-end middleware architecture according to the principles of the present invention.

FIG. 2a is a diagram illustrating an enterprise infrastructure physical deployment with the message appliances (MAs) creating a network backbone disintermediation.

FIG. 3 illustrates a channel-based messaging system architecture.

FIG. 4 illustrates one possible topic-based message format

FIG. 5 shows a topic-based message routing and routing table.

FIG. 6 illustrates an intelligent messaging application programming interface (API).

FIG. 7 illustrates the impact of adaptive message flow control.

FIGS. 8a and 8b illustrate intelligent network interface card (NIC) configurations.

FIG. 9 illustrates session-based fault tolerant design.

FIG. 10 illustrates messaging appliance (MA) to API interface.

### DETAILED DESCRIPTION

The description herein provides details of the end-to-end middleware architecture of a message publish-subscribe system and in particular the details of an intelligent messaging application programming interface (API) in accordance with various embodiments of the present invention. Before outlining the details of these various embodiments, however, the following is a brief explanation of terms used in this description. It is noted that this explanation is intended to merely clarify and give the reader an understanding of how such terms might be used, but without limiting these terms to the context in which they are used and without limiting the scope of the claims thereby.

The term “middleware” is used in the computer industry as a general term for any programming that mediates between two separate and often already existing programs. The purpose of adding the middleware is to offload from applications some of the complexities associated with information exchange by, among other things, defining communication interfaces between all participants in the network (publishers and subscribers). Typically, middleware programs provide messaging services so that different applications can communicate. With a middleware software layer, information exchange between applications is performed seamlessly. The systematic tying together of disparate applications, often through the use of middleware, is known as enterprise application integration (EAI). In this context, however, “middleware” can be a broader term used in connection with messaging between source and destination and the facilities deployed to enable such messaging; and, thus, middleware architecture covers the networking and computer hardware and software components that facilitate effective data messaging, individually and in combination as will be described below. Moreover, the terms “messaging system” or “middleware system,” can be used in the context of publish/subscribe systems in which messaging servers manage the routing of messages between publishers and subscribers. Indeed, the paradigm of publish/subscribe in messaging middleware is a scalable and thus powerful model.

The term “consumer” may be used in the context of client-server applications and the like. In one instance a consumer is a system or an application that uses an application programming interface (API) to register to a middleware system, to subscribe to information, and to receive data delivered by or send data delivered to the middleware system. An API inside the publish/subscribe middleware architecture boundaries is a consumer; and an external consumer is any publish/subscribe system (or external data destination) that doesn't use the API and for communications with which messages go through protocol transformation (as will be later explained).

The term “external data source” may be used in the context of data distribution and message publish/subscribe systems. In one instance, an external data source is regarded as a system or application, located within or outside the enterprise private network, which publishes messages in one of the common protocols or its own message protocol. An example of an external data source is a market data exchange that publishes stock market quotes which are distributed to traders via the middleware system. Another example of the external data source is transactional data. Note that in a typical implementation of the present invention, as will be later described in more detail, the middleware architecture adopts its unique native protocol to which data from external data sources is converted once it enters the middleware system domain, thereby avoiding multiple protocol transformations typical of conventional systems.

The term “external data destination” is also used in the context of data distribution and message publish/subscribe systems. An external data destination is, for instance, a system or application, located within or outside the enterprise private network, which is subscribing to information routed via a local/global network. One example of an external data destination could be the aforementioned market data exchange that handles transaction orders published by the traders. Another example of the external data destination is transactional data. Note that, in the foregoing middleware architecture messages directed to an external data destination are translated from the native protocol to the external protocol associated with the external data destination.

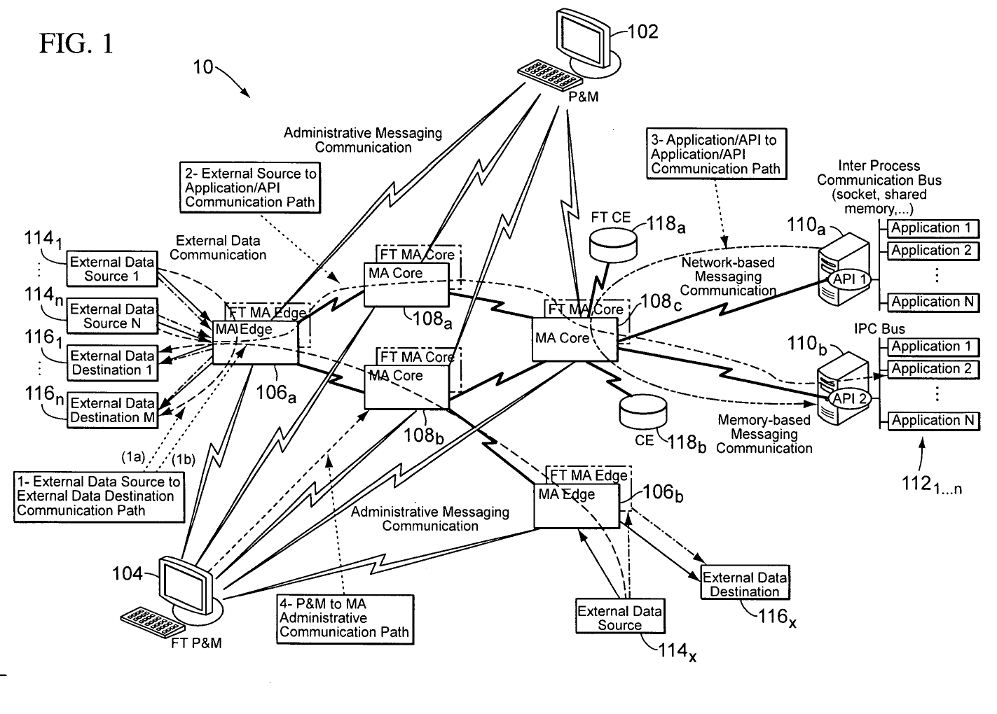

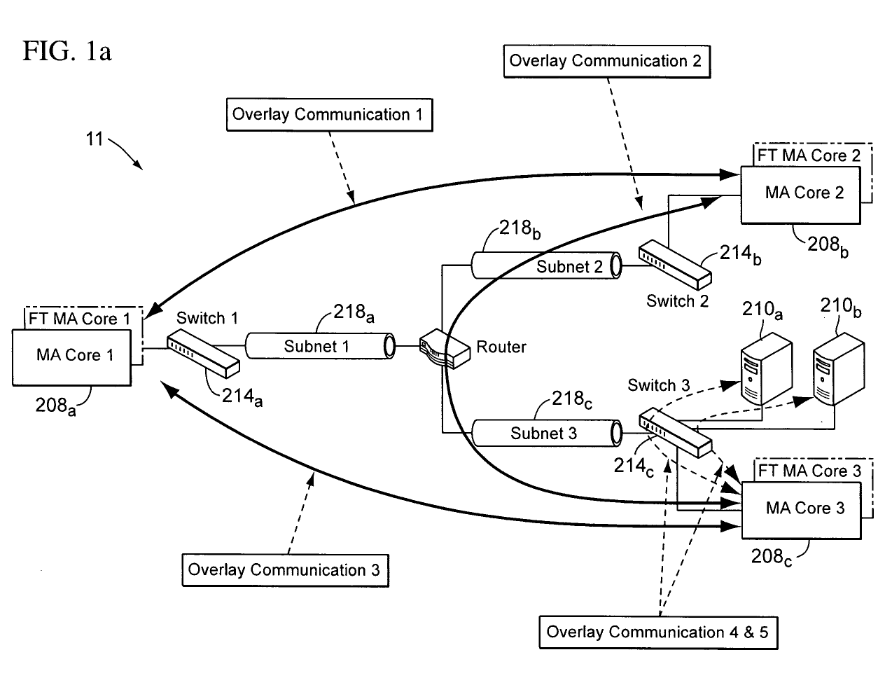

The term “bus” is typically used to describe an interconnect, and it can be a hardware or software-based interconnect. For example, the term bus can be used to describe an inter-process communication link such as that which uses a socket and shared memory, and it can be also used to describe an intra-process link such as a function call. As can be ascertained from the description herein, the present invention can be practiced in various ways with the intelligent messaging application programming interface (hereafter “API”) being implemented in various configurations within the middleware architecture. The description therefore starts with an example of an end-to-end middleware architecture as shown in FIG. 1.

This exemplary architecture combines a number of beneficial features which include: messaging common concepts, APIs, fault tolerance, provisioning and management (P&M), quality of service (QoS—conflated, best-effort, guaranteed-while-connected, guaranteed-during-disconnected etc.), persistent caching for guaranteed delivery QoS, management of namespace and security service, a publish/subscribe ecosystem (core, ingress and egress components), transport-transparent messaging, neighbor-based messaging (a model that is a hybrid between hub-and-spoke, peer-to-peer, and store-and-forward, and which uses a subscription-based routing protocol that can propagate the subscriptions to all neighbors as necessary), late schema binding, partial publishing (publishing changed information only as opposed to the entire data) and dynamic allocation of network and system resources. As will be later explained, the publish/subscribe middleware system advantageously incorporates a fault tolerant design of the middleware architecture. In every publish/subscribe ecosystem there is at least one and more often two or more messaging appliances (MA) each of which being configured to function as an edge (egress/ingress) MA or a core MA. Note that the core MAs portion of the publish/subscribe ecosystem uses the aforementioned native messaging protocol (native to the middleware system) while the ingress and egress portions, the edge MAs, translate to and from this native protocol, respectively.

In addition to the publish/subscribe middleware system components, the diagram of FIG. 1 shows the logical connections and communications between them. As can be seen, the illustrated middleware architecture is that of a distributed system. In a system with this architecture, a logical communication between two distinct physical components is established with a message stream and associated message protocol. The message stream contains one of two categories of messages: administrative and data messages. The administrative messages are used for management and control of the different physical components, management of subscriptions to data, and more. The data messages are used for transporting data between sources and destinations, and in a typical publish/subscribe messaging there are multiple senders and multiple receivers of data messages.

With the structural configuration and logical communications as illustrated the distributed messaging system with the publish/subscribe middleware architecture is designed to perform a number of logical functions. One logical function is message protocol translation which is advantageously performed at an edge messaging appliance (MA) component. This is because communications within the boundaries of the publish/subscribe middleware system are conducted using the native protocol for messages independently from the underlying transport logic. This is why we refer to this architecture as being a transport-transparent channel-based messaging architecture.

A second logical function is routing the messages from publishers to subscribers. Note that the messages are routed throughout the publish/subscribe network. Thus, the routing function is performed by each MA where messages are propagated, say, from an edge MA 106a-b (or API) to a core MA 108a-c or from one core MA to another core MA and eventually to an edge MA (e.g., 106b) or API 110a-b. The API 110a-b communicates with applications 112₁₋ₙ for publishing of and subscribing to messages via an inter-process communication bus (sockets, shared memory etc.) or via an inter-process communication bus such as a function call.

A third logical function is storing messages for different types of guaranteed-delivery quality of service, including for instance guaranteed-while-connected and guaranteed-while-disconnected. This is accomplished with the addition of store-and-forward functionality.

A fourth function is delivering these messages to the subscribers (as shown, an API 106a-b delivers messages to subscribing applications 112₁₋ₙ).

In this publish/subscribe middleware architecture, the system configuration function as well as other administrative and system performance monitoring functions, are managed by the P&M system. Configuration involves both physical and logical configuration of the publish/subscribe middleware system network and components. The monitoring and reporting involves monitoring the health of all network and system components and reporting the results automatically, per demand or to a log. The P&M system performs its configuration, monitoring and reporting functions via administrative messages. In addition, the P&M system allows the system administrator to define a message namespace associated with each of the messages routed throughout the publish/subscribe network. Accordingly, a publish/subscribe network can be physically and/or logically divided into namespace-based sub-networks.

The P&M system manages a publish/subscribe middleware system with one or more MAs. These MAs are deployed as edge MAs or core MAs, depending on their role in the system. An edge MA is similar to a core MA in most respects, except that it includes a protocol translation engine that transforms messages from native protocols and from native to external protocols. Thus, in general, the boundaries of the publish/subscribe middleware architecture in a messaging system (i.e., the end-to-end publish/subscribe middleware system boundaries) are characterized by its edges at which there are edge MAs 106a-b and APIs 110a-b; and within these boundaries there are core MAs 108a-c.

Note that the system architecture is not confined to a particular limited geographic area and, in fact, is designed to transcend regional or national boundaries and even span across continents. In such cases, the edge MAs in one network can communicate with the edge MAs in another geographically distant network via existing networking infrastructures.

In a typical system, the core MAs 108a-c route the published messages internally within publish/subscribe middleware system towards the edge MAs or APIs (e.g., APIs 110a-b). The routing map, particularly in the core MAs, is designed for maximum volume, low latency, and efficient routing. Moreover, the routing between the core MAs can change dynamically in real-time. For a given messaging path that traverses a number of nodes (core MAs), a real time change of routing is based on one or more metrics, including network utilization, overall end-to-end latency, communications volume, network and/or message delay, loss and jitter.

Alternatively, instead of dynamically selecting the best performing path out of two or more diverse paths, the MA can perform multi-path routing based on message replication and thus send the same message across all paths. All the MAs located at convergence points of diverse paths will drop the duplicated messages and forward only the first arrived message. This routing approach has the advantage of optimizing the messaging infrastructure for low latency; although the drawback of this routing method is that the infrastructure requires more network bandwidth to carry the duplicated traffic.

The edge MAs have the ability to convert any external message protocol of incoming messages to the middleware system's native message protocol; and from native to external protocol for outgoing messages. That is, an external protocol is converted to the native (e.g., Tervela™) message protocol when messages are entering the publish/subscribe network domain (ingress); and the native protocol is converted into the external protocol when messages exit the publish/subscribe network domain (egress). The edge MAs operate also to deliver the published messages to the subscribing external data destinations.

Additionally, both the edge and the core MAs 106a-b and 108a-c are capable of storing the messages before forwarding them. One way this can be done is with a caching engine (CE) 118a-b. One or more CEs can be connected to the same MA. Theoretically, the API is said not to have this store-and-forward capability although in reality an API 110a-b could store messages before delivering them to the application, and it can store messages received from (i.e., published by) applications before delivering them to a core MA, edge MA or another API.

When an MA (edge or core MA) has an active connection to a CE, it forwards all or a subset of the routed messages to the CE which writes them to a storage area for persistency. For a predetermined period of time, these messages are then available for retransmission upon request. Examples where this feature is implemented are data replay, partial publish and various quality of service levels. Partial publish is effective in reducing network and consumers load because it requires transmission only of updated information rather than of all information.

To illustrate how the routing maps might affect routing, a few examples of the publish/subscribe routing paths are shown in FIG. 1. In this illustration, the middleware architecture of the publish/subscribe network provides five or more different communication paths between publishers and subscribers.

The first communication path links an external data source to an external data destination. The published messages received from the external data source 114₁₋ₙ are translated into the native (e.g., Tervela™) message protocol and then routed by the edge MA 106a. One way the native protocol messages can be routed from the edge MA 106a is to an external data destination 116n. This path is called out as communication path 1a. In this case, the native protocol messages are converted into the external protocol messages suitable for the external data destination. Another way the native protocol messages can be routed from the edge MA 106b is internally through a core MA 108b. This path is called out as communication path 1b. Along this path, the core MA 108b routes the native messages to an edge MA 106a. However, before the edge MA 106a routes the native protocol messages to the external data destination 116₁, it converts them into an external message protocol suitable for this external data destination 116₁. As can be seen, this communication path doesn't require the API to route the messages from the publishers to the subscribers. Therefore, if the publish/subscribe middleware system is used for external source-to-destination communications, the system need not include an API.

Another communication path, called out as communications path 2, links an external data source 114n to an application using the API 110b. Published messages received from the external data source are translated at the edge MA 106a into the native message protocol and are then routed by the edge MA to a core MA 108a. From the first core MA 108a, the messages are routed through another core MA 108c to the API 110b. From the API the messages are delivered to subscribing applications (e.g., 112₂). Because the communication paths are bidirectional, in another instance, messages could follow a reverse path from the subscribing applications 112₁₋ₙ to the external data destination 116n. In each instance, core MAs receive and route native protocol messages while edge MAs receive external or native protocol messages and, respectively, route native or external protocol messages (edge MAs translate to/from such external message protocol to/from the native message protocol). Each edge MA can route an ingress message simultaneously to both native protocol channels and external protocol channels regardless of whether this ingress message comes in as a native or external protocol message. As a result, each edge MA can route an ingress message simultaneously to both external and internal consumers, where internal consumers consume native protocol messages and external consumers consume external protocol messages. This capability enables the messaging infrastructure to seamlessly and smoothly integrate with legacy applications and systems.

Yet another communication path, called out as communications path 3, links two applications, both using an API 110a-b. At least one of the applications publishes messages or subscribes to messages. The delivery of published messages to (or from) subscribing (or publishing) applications is done via an API that sits on the edge of the publish/subscribe network. When applications subscribe to messages, one of the core or edge MAs routes the messages towards the API which, in turn, notifies the subscribing applications when the data is ready to be delivered to them. Messages published from an application are sent via the API to the core MA 108c to which the API is ‘registered’.

Note that by ‘registering’ (logging in) with an MA, the API becomes logically connected to it. An API initiates the connection to the MA by sending a registration (‘log-in’ request) message to the MA. After registration, the API can subscribe to particular topics of interest by sending its subscription messages to the MA. Topics are used for publish/subscribe messaging to define shared access domains and the targets for a message, and therefore a subscription to one or more topics permits reception and transmission of messages with such topic notations. The P&M sends to the MAs in the network periodic entitlement updates and each MA updates it own table accordingly. Hence, if the MA find the API to be entitled to subscribe to a particular topic (the MA verifies the API's entitlements using the routing entitlements table) the MA activates the logical connection to the API. Then, if the API is properly registered with it, the core MA 108c routes the data to the second API 110 as shown. In other instances this core MA 108b may route the messages through additional one or more core MAs (not shown) which route the messages to the API 110b that, in turn, delivers the messages to subscribing applications 112₁₋ₙ.

As can be seen, communications path 3 doesn't require the presence of an edge MA, because it doesn't involve any external data message protocol. In one embodiment exemplifying this kind of communications path, an enterprise system is configured with a news server that publishes to employees the latest news on various topics. To receive the news, employees subscribe to their topics of interest via a news browser application using the API.

Note that the middleware architecture allows subscription to one or more topics. Moreover, this architecture allows subscription to a group of related topics with a single subscription request, by allowing wildcards in the topic notation.

Yet another path, called out as communications path 4, is one of the many paths associated with the P&M system 102 and 104 with each of them linking the P&M to one of the MAs in the publish/subscribe network middleware architecture. The messages going back and forth between the P&M system and each MA are administrative messages used to configure and monitor that MA. In one system configuration, the P&M system communicates directly with the MAs. In another system configuration, the P&M system communicates with MAs through other MAs. In yet another configuration the P&M system can communicate with the MAs both directly or indirectly.

In a typical implementation, the middleware architecture can be deployed over a network with switches, router and other networking appliances, and it employs channel-based messaging capable of communications over any type of physical medium. One exemplary implementation of this fabric-agnostic channel-based messaging is an IP-based network. In this environment, all communications between all the publish/subscribe physical components are performed over UDP (User Datagram Protocol), and the transport reliability is provided by the messaging layer. An overlay network according to this principle is illustrated in FIG. 1a.

As shown, overlay communications 1, 2 and 3 can occur between the three core MAs 208a-c via switches 214a-c, a router 216 and subnets 218a-c. In other words, these communication paths can be established on top of the underlying middleware network which is composed of networking infrastructure such as subnets, switches and routers, and, as mentioned, this architecture can span over a large geographic area (different countries and even different continents).

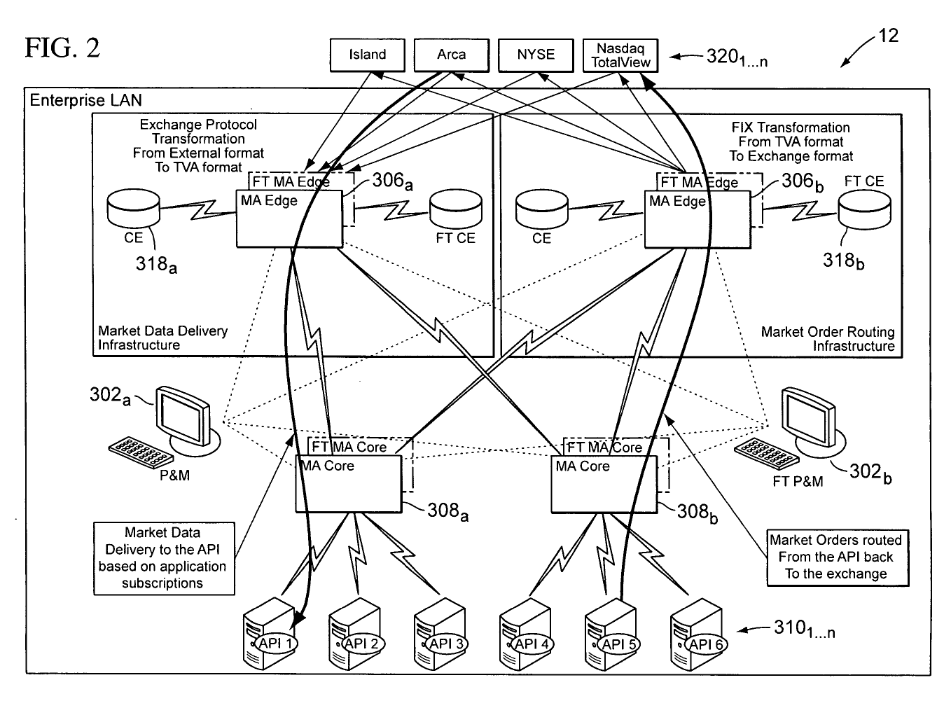

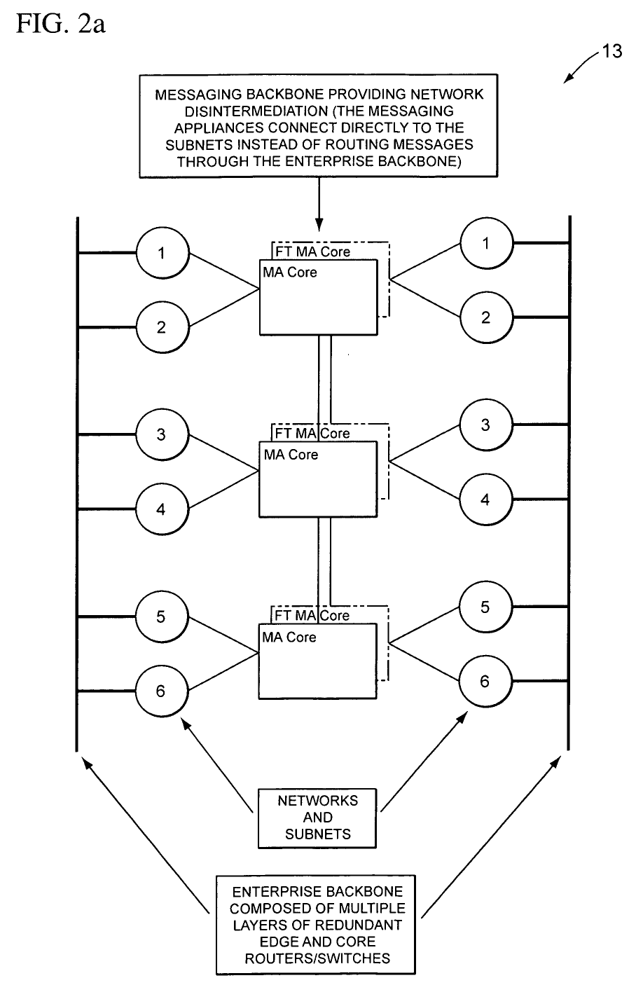

Notably, the foregoing and other end-to-end middleware architectures according to the principles of the present invention can be implemented in various enterprise infrastructures in various business environments. One such implementation is illustrated on FIG. 2.

In this enterprise infrastructure, a market data distribution plant 12 is built on top of the publish/subscribe network for routing stock market quotes from the various market data exchanges 320₁₋ₙ to the traders (applications not shown). Such an overlay solution relies on the underlying network for providing interconnects, for instance, between the MAs as well as between such MAs and the P&M system. Market data delivery to the APIs 310₁₋ₙ is based on applications subscription. With this infrastructure, traders using the applications (not shown) can place transaction orders that are routed from the APIs 310′-n through the publish/subscribe network (via core MAs 308a-b and the edge MA 306a) back to the market data exchanges 320i-n.

An example of the underlying physical deployment is illustrated on FIG. 2a. As shown, the MAs are directly connected to each other and plugged directly into the networks and subnets in which the consumers and publishers of messaging traffic are physically connected. In this case, interconnects would be direct connections, say, between the MAs as well as between them and the P&M system. This enables a network backbone disintermediation and a physical separation of the messaging traffic from other enterprise applications traffic. Effectively, the MAs can be used to remove the reliance on traditional routed network for the messaging traffic.

In this example of physical deployment, the external data sources or destinations, such as market data exchanges, are directly connected to edge MAs, for instance edge MA 1. The consuming or publishing applications of messaging traffic, such as trading applications, are connected to the subnets 1-12. These application have at least two ways to subscribe, publish or communicate with other applications; they could either use the enterprise backbone, composed of multiple layers of redundant routers and switches, which carries all enterprise application traffic, including—but not limited to—messaging traffic, or use the messaging backbone, composed of edge and core MAs directly interconnected to each other via an integrated switch.

Using an alternative backbone has the benefit of isolating the messaging traffic from other enterprise application traffic, and thus, better controlling the performance of the messaging traffic. In one implementation, an application located in subnet 6 logically or physically connected to the core MA 3, subscribes to or publishes messaging traffic in the native protocol, using the Tervela API. In another implementation, an application located in subnet 7 logically or physically connected to the edge MA 1, subscribes to or publishes the messaging traffic in an external protocol, where the MA performs the protocol transformation using the integrated protocol transformation engine module. Logically, the physical components of the publish/subscribe network are built on a messaging transport layer akin to layers 1 to 4 of the Open Systems Interconnection (OSI) reference model. Layers 1 to 4 of the OSI model are respectively the Physical, Data Link, Network and Transport layers.

Thus, in one embodiment of the invention, the publish/subscribe network can be directly deployed into the underlying network/fabric by, for instance, inserting one or more messaging line card in all or a subset of the network switches and routers. In another embodiment of the invention, the publish/subscribe network can be deployed as a mesh overlay network (in which all the physical components are connected to each other). For instance, a fully-meshed network of 4 MAs is a network in which each of the MAs is connected to each of its 3 peer MAs. In a typical implementation, the publish/subscribe network is a mesh network of one or more external data sources and/or destinations, one or more provisioning and management (P&M) systems, one or more messaging appliances (MAs), one or more optional caching engines (CE) and one or more optional application programming interfaces (APIs).

As mentioned before, communications within the boundaries of each publish/subscribe middleware system are conducted using the native protocol for messages independently from the underlying transport logic. This is why we refer to this architecture as a transport-transparent channel-based messaging architecture.

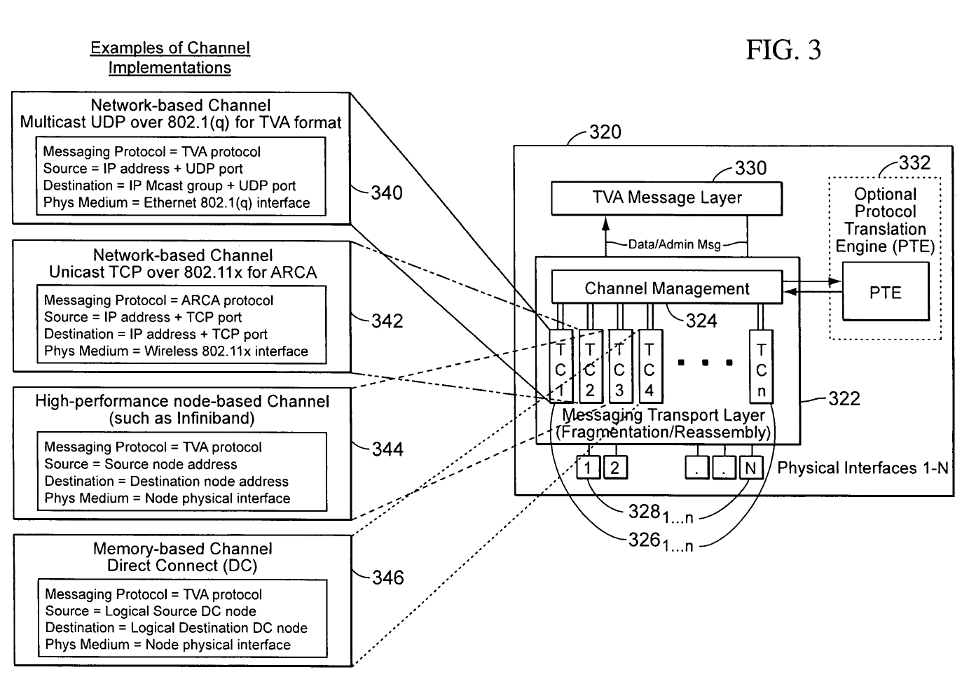

FIG. 3 illustrate in more details the channel-based messaging architecture 320. Generally, each communication path between the messaging source and destination is defined as a messaging transport channel. Each channel 326₁₋ₙ, is established over a physical medium with interfaces 328₁₋ₙ between the channel source and the channel destination. Each such channel is established for a specific message protocol, such as the native (e.g., Tervela™) message protocol or others. Only edge MAs (those that manage the ingress and egress of the publish/subscribe network) use the channel message protocol (external message protocol). Based on the channel message protocol, the channel management layer 324 determines whether incoming and outgoing messages require protocol translation. In each edge MA, if the channel message protocol of incoming messages is different from the native protocol, the channel management layer 324 will perform a protocol translation by sending the message for process through the protocol translation engine (PTE) 332 before passing them along to the native message layer 330. Also, in each edge MA, if the native message protocol of outgoing messages is different from the channel message protocol (external message protocol), the channel management layer 324 will perform a protocol translation by sending the message for process through the protocol translation engine (PTE) 332 before routing them to the transport channel 326₁₋ₙ. Hence, the channel manages the interface 328₁₋ₙ with the physical medium as well as the specific network and transport logic associated with that physical medium and the message reassembly or fragmentation.

In other words, a channel manages the OSI transport layers 322. Optimization of channel resources is done on a per channel basis (e.g., message density optimization for the physical medium based on consumption patterns, including bandwidth, message size distribution, channel destination resources and channel health statistics). Then, because the communication channels are fabric agnostic, no particular type of fabric is required. Indeed, any fabric medium will do, e.g., ATM, Infiniband or Ethernet.

Incidentally, message fragmentation or re-assembly may be needed when, for instance, a single message is split across multiple frames or multiple messages are packed in a single frame Message fragmentation or reassembly is done before delivering messages to the channel management layer

FIG. 3 further illustrates a number of possible channels implementations in a network with the middleware architecture. In one implementation 340, the communication is done via a network-based channel using multicast over an Ethernet switched network which serves as the physical medium for such communications. In this implementation the source send messages from its IP address, via its UDP port, to the group of destinations with respective UDP ports at their respective IP addresses (hence multicast). In a variation of this implementation 342, the communication between the source and destination is done over an Ethernet switched network using UDP unicast. From its IP address, the source sends messages, via a UDP port, to a select destination with a UDP port at its respective IP address.

In another implementation 344, the channel is established over an Infiniband interconnect using a native Infiniband transport protocol, where the Infiniband fabric is the physical medium. In this implementation the channel is node-based and communications between the source and destination are node-based using their respective node addresses. In yet another implementation 346, the channel is memory-based, such as RDMA (Remote Direct Memory Access), and referred to here as direct connect (DC). With this type of channel, messages are sent from a source machine directly into the destination machine's memory, thus, bypassing the CPU processing to handle the message from the NIC to the application memory space, and potentially bypassing the network overhead of encapsulating messages into network packets.

As to the native protocol, one approach uses the aforementioned native Tervela™ message protocol. Conceptually, the Tervela™ message protocol is similar to an IP-based protocol. Each message contains a message header and a message payload. The message header contains a number of fields one of which is for the topic information indicating topics used by consumers to subscribe to a shared domain of information.

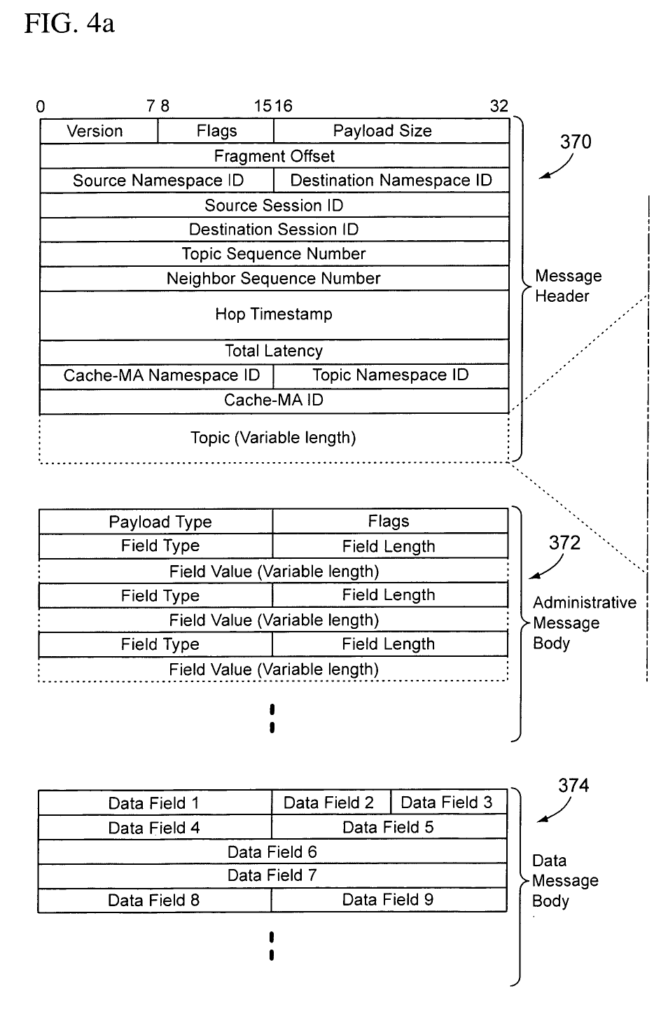

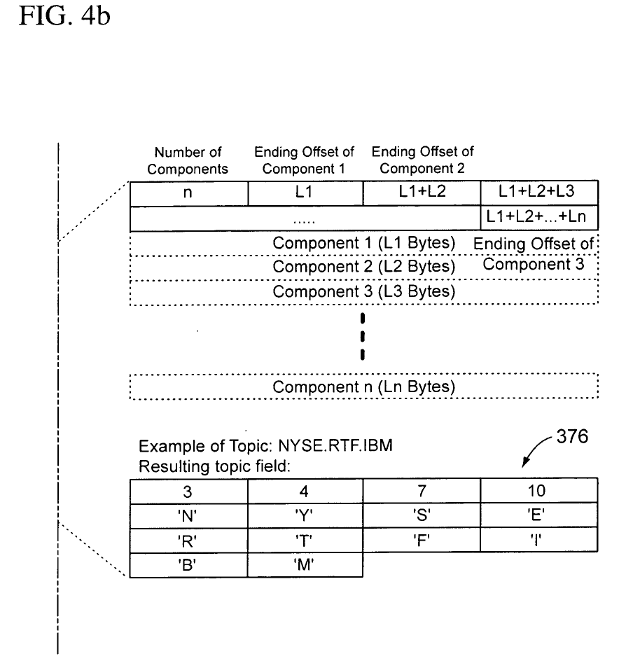

FIG. 4 illustrates one possible topic-based message format. As shown, messages include a header 370 and a body 372 and 374 which includes the payload. The two types of messages, data and administrative are shown with different message bodies and payload types. The header includes fields for the source and destination namespace identifications, source and destination session identifications, topic sequence number and hope timestamp, and, in addition, it includes the topic notation field (which is preferably of variable length). The topic might be defined as a token-based string, such as NYSE.RTF.IBM 376 which is the topic string for messages containing the real time quote of the IBM stock.

In one embodiment, the topic information in the message might be encoded or mapped to a key, which can be one or more integer values. Then, each topic would be mapped to a unique key, and the mapping database between topics and keys would be maintained by the P&M system and updated over the wire to all MAs. As a result, when an API subscribes or publishes to one topic, the MA is able to return the associated unique key that is used for the topic field of the message.

Preferably, the subscription format will follow the same format as the message topic. However, the subscription format also supports wildcard-matching with any topic substring as well as regular expression pattern-matching with the topic string. Mapping wildcards to actual topics may be dependant on the P&M subsystem or it can be handled by the MA, depending on the complexity of the wildcard or pattern-match request.

For instance, such pattern matching may follow rules such as:

### EXAMPLE #1

A string with a wildcard of T1.*.T3.T4 would match T1.T2a.T3.T4 and T1.T2b.T3.T4 but would not match T1.T2.T3.T4.T5

### EXAMPLE #2

A string with wildcards of T1.*.T3.T4.* would not match T1.T2a.T3.T4 and T1.T2b.T3.T4 but it would match T1.T2.T3.T4.T5

### EXAMPLE #3

A string with wildcards of T1.*.T3.T4[*] (optional 5^{th} element) would match T1.T2a.T3.T4, T1.T2b.T3.T4 and T1.T2.T3.T4.T5 but not match T1.T2.T3.T4.T5.T6

### EXAMPLE #4

A string with a wildcard of T1.T2*.T3.T4 would match T1.T2a.T3.T4 and T1.T2b.T3.T4 but would not match T1.T5a.T3.T4

### EXAMPLE #5

A string with wildcards of T1.*.T3.T4.> (any number of trailing elements) would match T1.T2a.T3.T4, T1.T2b.T3.T4, T1.T2.T3.T4.T5 and T1.T2.T3.T4.T5.T6.

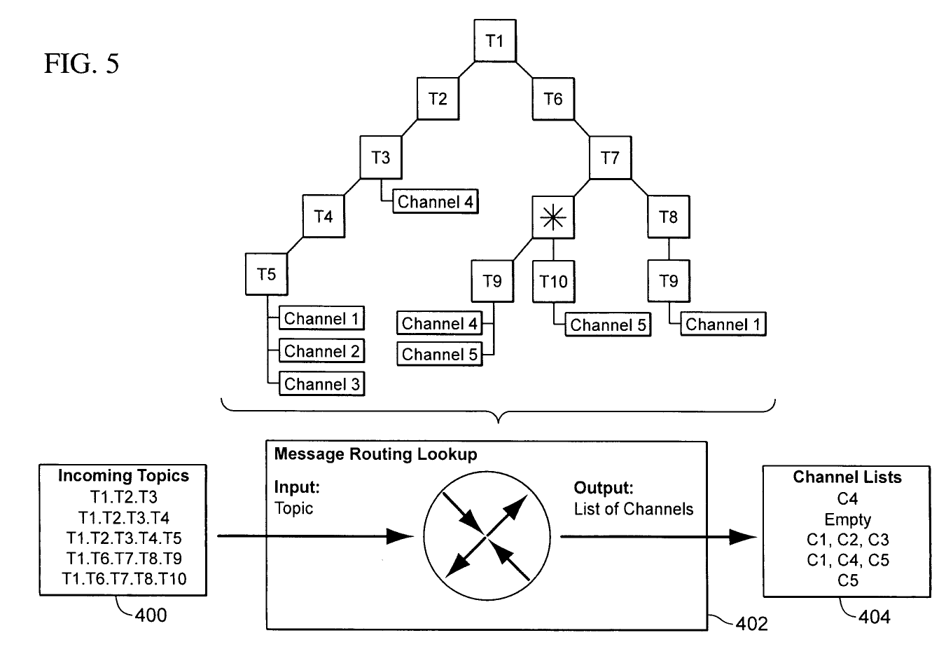

FIG. 5 shows topic-based message routing with topics often defined as token-based strings, such as T1.T2.T3.T4, where T1, T2, T3 and T4 are strings of variable lengths. As can be seen, incoming messages with particular topic notations 400 are selectively routed to communications channels 404, and the routing determination is made based on a routing table 402. The mapping of the topic subscription to the channel defines the route and is used to propagate messages throughout the publish/subscribe network. The superset of all these routes, or mapping between subscriptions and channels, defines the routing table. The routing table is also referred to as the subscription table. The subscription table for routing via string-based topics can be structured in a number of ways, but is preferably configured for optimizing its size as well as the routing lookup speed. In one implementation, the subscription table may be defined as a dynamic hash map structure, and in another implementation, the subscription table may be arranged in a tree structure as shown in the diagram of FIG. 5.

A tree includes nodes (e.g., T₁, . . . T₁₀) connected by edges, where each sub-string of a topic subscription corresponds to a node in the tree. The channels mapped to a given subscription are stored on the leaf node of that subscription indicating, for each leaf node, the list of channels from where the topic subscription came (i.e. through which subscription requests were received). This list indicates which channel should receive a copy of the message whose topic notation matches the subscription. As shown, the message routing lookup takes a message topic as input and parse the tree using each substring of that topic to locate the different channels associated with the incoming message topic. For instance, T₁, T₂, T₃, T₄ and T₅ are directed to channels 1, 2 and 3; T₁, T₂, and T₃, are directed to channel 4; T₁, T₆, T₇, T* and T₉ are directed to channels 4 and 5; T₁, T₆, T₇, T₈ and T₉ are directed to channel 1; and T₁, T₆, T₇, T* and T₁₀ are directed to channel 5.

Although selection of the routing table structure is directed to optimizing the routing table lookup, performance of the lookup depends also on the search algorithm for finding the one or more topic subscriptions that match an incoming message topic. Therefore, the routing table structure should be able to accommodate such algorithm and vice versa. One way to reduce the size of the routing table is by allowing the routing algorithm to selectively propagate the subscriptions throughout the entire publish/subscribe network. For example, if a subscription appears to be a subset of another subscription (e.g., a portion of the entire string) that has already been propagated, there is no need to propagate the subset subscription since the MAs already have the information for the superset of this subscription.

Based on the foregoing, the preferred message routing protocol is a topic-based routing protocol, where entitlements are indicated in the mapping between subscribers and respective topics. Entitlements are designated per subscriber and indicate what messages the subscriber has a right to consume, or which messages may be produced (published) by such publisher. These entitlements are defined in the P&M machine, communicated to all MAs in the publish/subscribe network, and then used by the MA to create and update their routing tables.

Each MA updates its routing table by keeping track of who is interested in (requesting subscription to) what topic. However, before adding a route to its routing table, the MA has to check the subscription against the entitlements of the publish/subscribe network. The MA verifies that a subscribing entity, which can be a neighboring MA, the P&M system, a CE or an API, is authorized to do so. If the subscription is valid, the route will be created and added to the routing table. Then, because some entitlements may be known in advance, the system can be deployed with predefined entitlements and these entitlements can be automatically loaded at boot time. For instance, some specific administrative messages such as configuration updates or the like might be always forwarded throughout the network and therefore automatically loaded at startup time.

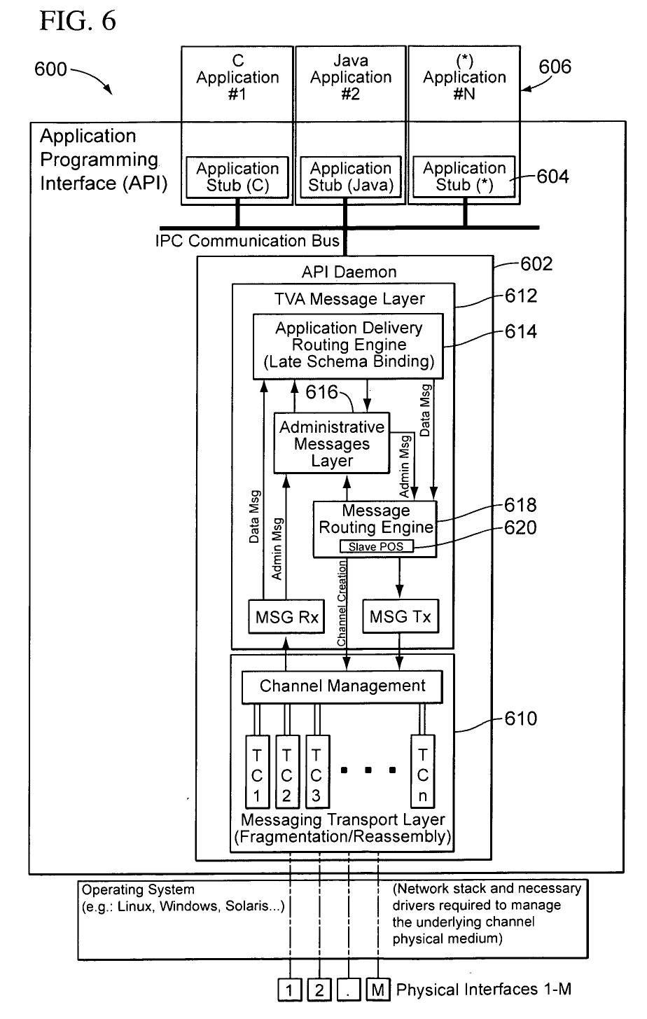

Given the description above of messaging systems with the publish/subscribe middleware architecture, it can be understood that, in handling messaging for applications, intelligent messaging application programming interfaces, herein referred to simply as APIs, have a considerable role in such systems. Applications rely on the API for all messaging including for registering, publishing and subscribing. The registration includes sending an administrative registration request to one or more MAs which confirm entitlement of the API and application to so register. Once their registration is validated, application can subscribe to and publish information on any topic to which they are entitled. Accordingly, we turn now to describe the details of APIs configured in accordance with the principles of the present invention. FIG. 6 is a block diagram illustrating an API.

In this illustration, the API is a combination of an API communication engine 602 and API stubs 604. A communication engine 602 is known generally as a program that runs under the operating system for the purpose of handling periodic service requests that a computer system expects to receive; but in some instances it is embedded in the applications themselves and is thus an intra-process communication bus. The communication engine program forwards the requests to other programs (or processes) as appropriate. In this instance, the API communication engine acts as a gateway between applications and the publish/subscribe middleware system. As such, the API communication engine manages application communications with MAs by, among other things, dynamically selecting the transport protocol and dynamically adjusting the number of messages to pack in a single frame. The number of messages packed in a single fame is dependent on factors such as the message rate and system resource utilization in both the MA and the API host.

The API stubs 604 are used by the applications to communicate with the API communication engine. Generally, an application program that uses remote procedure calls (RPCs) is compiled with stubs that substitute for the program(s) with the requested remote procedure(s). A stub accepts a PRC and forwards it to the remote procedure which, upon completion, returns the results to the stub for passing the result to the program that made the PRC. In some instances, communications between the API stubs and the API communication engine are done via an inter-process communication bus which is implemented using mechanisms such as sockets or shared memory. The API stubs are available in various programming languages, including C, C++, Java and .NET. The API itself might be available in its entirety in multiple languages and it can run on different Operating Systems, including MS Windows™, Linux™ and Solaris™.

The API communication engine 602 and API stubs 604 are compiled and linked to all the applications 606 that are using the API. Communications between the API stubs and the API communication engine are done via an inter-process communication bus 608, implemented using mechanisms such as sockets or shared memory. The API stubs 604 are available in various programming languages, including C, C++, Java and NET. In some instances, the API itself might be available in multiple languages. The API runs on various operating system platforms three examples of which are Windows™, Linux™ and Solaris™.

The API communication engine is built on logical layers such as a messaging transport layer 610. Unlike the MA which interacts directly with the physical medium interfaces, the API sits in most implementations on top of an operating system (as is the case with the P&M system) and its messaging transport layer communicates via the OS. In order to support different types of channels, the OS may require specific drivers for each physical medium that is otherwise not supported by the OS by default. The OS might also require the user to insert a specific physical medium card. For instance, physical mediums such as direct connect (DC) or Infiniband require a specific interface card and its associated OS driver to allow the messaging transport layer to send messages over the channel.

The messaging layer 612 in an API is also somewhat similar to a messaging layer in an MA. The main difference, however, is that the incoming messages follow different paths in the API and MA, respectively. In the API, the data messages are sent to the application delivery routing engine 614 (less schema bindings) and the administrative messages are sent to the administrative messages layer 616. The application delivery routing engine behaves similarly to the message routing engine 618, except that instead of mapping channels to subscriptions it maps applications (606) to subscriptions. Thus, when an incoming message arrives, the application delivery routing engine looks up for all subscribing applications and then sends a copy of this message or a reference to this message to all of them.

In some implementations, the application delivery routing engine is responsible for the late schema binding feature. As mentioned earlier, the native (e.g., Tervela™) messaging protocol provides the information in a raw and compressed format that doesn't contain the structure and definition of the underlying data. As a result, the messaging system beneficially reduces its bandwidth utilization and, in turn, allows increased message volume and throughput. When a data message is received by the API, the API binds the raw data to its schema, allowing the application to transparently access the information. The schema defines the content structure of the message by providing a mapping between field name, type of field, and its offset location in the message body. Therefore, the application can ask for a specific field name without knowing its location in the message, and the API uses the offset to locate and return that information to the application. In one implementation, the schema is provided by the MA when the applications request to subscribe or publish from/to the MA.

To a large extent, outgoing messages follow the same outbound logic as in an MA. Indeed, the API may have a protocol optimization service (POS) 620 as does an MA. However, the publish/subscribe middleware system is configured with the POS distributed between the MA and the API communication engine in a master-slave-based configuration. However, unlike the POS in the MA which makes its own decisions on when to change the channel configurations, the POS in the API acts as a slave of the master POS in the MA to which it is linked. Both the master POS and slave POS monitor the consumption patterns over time of system and network resources. The slave POS communicates all, a subset, or a summary of these resource consumption patterns to the master POS and based on these patterns the master POS determines how to deliver the messages to the API communication engine, including by selecting a transport protocol. For instance, a transport protocol selected from among the unicast, multicast or broadcast message transport protocols is not always suitable for the circumstances. Thus, when the POS on the MA decides to change the channel configurations, it remotely controls the slave POS at the API.

In performing its role in the messaging publish/subscribe middleware system, the API is preferably transparent to the applications in that it minimizes utilization of system resources for handling application requests. In one configuration, the API optimizes the number of memory copies by performing a zero-copy message receive (i.e.: omitting the copy to the application memory space of messages received from the network). For instance, the API communication engine introduces a buffer (memory space) to the network interface card for writing incoming messages directly into the API communication engine memory space. These messages become accessible to the applications via shared memory. Similarly, the API performs a zero-copy message transmit from the application memory space directly to the network.

In another configuration, the API reduces the required amount of CPU processing for performing the message receive and transmit tasks. For instance, instead of receiving or transmitting one message at the time, the API communication engine performs bulk message receive and transmit tasks, thereby reducing the number of CPU processing cycles. Such bulk message transfers often involve message queuing. Therefore, in order to minimize end-to-end latency bulk message transfers require restricting the time of keeping messages queued to less than an acceptable latency threshold.

For maintaining the aforementioned transparency the API processes messages published or subscribed to by applications. To reduce system bandwidth utilization and, thereby, increase system throughput, the message information is communicated in raw and compressed format. Hence, when the API receives a data message, the API binds the raw data to its schema, allowing applications to transparently access the information. The schema defines the content structure of the message by providing a mapping between field name, type of field, and field index in the message body. As a result, the application can ask for a specific field name without knowing its location in the message, and the API uses the field index and its associated offset to locate and return that information to the application. Incidentally, to make more efficient use of the bandwidth, an application can subscribe to a topic where it requests to receive only the updated information from the message stream. As a result of such subscription, the MA compares new messages to previously delivered messages and publishes to the application only updates.

Another implementation provides the ability to present the received or published data in a pre-agreed format between the subscribing applications and the API. This conversion of the content is performed by a presentation engine and is based on the data presentation format provided by the application. The data presentation format might be defined as a mapping between the underlying data schema and the application data format. For instance, the application might publish and consume data in an XML format, and the API will convert to and from this XML format to the underlying message format.

The API is further designed for real-time channel optimization. Specifically, communications between the MA and the API communication engine are performed over one or more channels each transporting the messages that correspond to one or more subscriptions or publications. Both the MA and the API communication engine constantly monitor each of the communication paths and dynamically optimize the available resources. This is done to minimize the processing overhead related to data publications/subscriptions and to reserve the necessary and expected system resources for publishing and subscribing applications.

In one implementation, the API communication engine enables a real-time channel message flow control feature for protecting the one or more applications from running out of available system resources. This message flow control feature is governed by the subscribed QoSs (quality of service). For instance, for last-known-value or best-effort QoS, it is often more important to process less data of good quality than more data of poor quality. If the quality of data is measured by its age, for instance, it may be better to process only the most up-to-date information. Moreover, instead of waiting for the queue to overflow and leave the applications with the burden of processing old data and dropping the most recent data, the API communication engine notifies the MA about the current state of the channel queues.

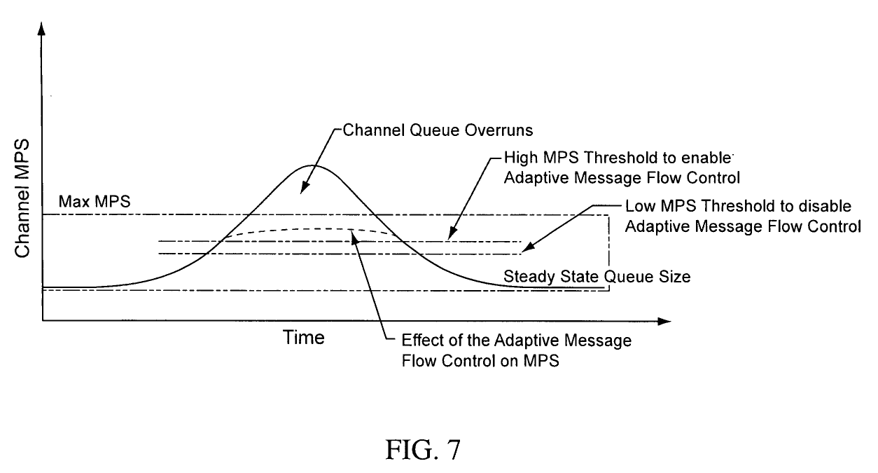

FIG. 7 illustrates the effects of a real-time message flow control (MFC) algorithm. According to this algorithm, the size of a channel queue can operate as a threshold parameter. For instance, messages delivered through a particular channel accumulate in its channel queue at the receiving appliance side, and as this channel queue grows its size may reach a high threshold that it cannot safely exceed without the channel possibly failing to keep up with the flow of incoming messages. When getting close to this situation, where the channel is at risk of reaching its maximum capacity, the receiving messaging appliance can activate the MFC before the channel queue is overrun. The MFC is turned off when the queue shrinks and its size becomes smaller than a low threshold. The difference between the high and low thresholds is set to be sufficient for producing this so called hysteresis behavior, where the MFC is turned on at a higher queue size value than that at which it is turned off. This threshold difference avoids frequent on-off oscillations of the message flow control that would otherwise occur as the queue size hovers around the high threshold. Thus, to avoid queue overruns on the messaging receiver side, the rate of incoming messages can be kept in check with a real-time, dynamic MFC which keeps the rate below the maximum channel capacity.

As an alternative to the hysteresis-based MFC algorithm where messages are dropped when the channel queue nears its capacity, the real-time, dynamic MFC can operates to blend the data or apply some conflation algorithm on the subscription queues. However, because this operation may require an additional message transformation, the MA may fall back to a slow forwarding path as opposed to remaining on the fast forwarding path. This would prevent the message transformation from having a negative impact on the messaging throughput. The additional message transformation is performed by a processor similar to the protocol translation engine. Examples of such processor include an NPU (network processing unit), a semantic processor, a separate micro-engine on the MA and the like.

For greater efficiency, the real-time conflation or subscription-level message processing can be distributed between the sender and the receiver. For instance, in the case where subscription-level message processing is requested by only one subscriber, it would make sense to push it downstream on the receiver side as opposed to performing it on the sender side. However, if more than one consumer of the data is requesting the same subscription-level message processing, it would make more sense to perform it upstream on the sender side. The purpose of distributing the workload between the sender and receiver-side of a channel is to optimally use the available combined processing resources.

When the channel packs multiple messages in a single frame it can keep message latency below the maximum acceptable latency and ease the stress on the receive side by freeing some processing resources. It is sometimes more efficient to receive fewer large frames than processing many small frames. This is especially true for the API that might run on a typical OS using generic computer hardware components including CPU, memory and NICs. Typical NICs are designed to generate an OS interrupt for each received frame, which in-turn reduces the application-level processing time available for the API to deliver messages to the subscribing applications.

As further shown in FIG. 7, if the current level of the channel queue crosses a maximum threshold, the MA throttles the message rate on this particular channel to reduce the load on the API communication engine and allow the applications to return to a steady state. During this throttling process, depending on the subscribed quality of service, the most recent messages will be prioritized over the old ones. If the queues go back to a normal load level, the API might notify the MA to disable the channel message flow control.

In one variation of the foregoing implementation, the message flow control feature is implemented on the API side of the message routing path (to/from applications). Whenever a message needs to be delivered to a subscribing application, the API communication engine can make the decision to drop the message in favor of a following more recent message if allowed by the subscribed quality of service.

Either way, in the API or in the MA, the message flow control can apply a different throttling policy, where instead of dropping old messages in favor of new ones, the API communication engine, or the MA connected to this API communication engine, might perform a subscription-based data conflation, also known as data blending. In other words, the dropped data is not completely lost but it is blended with the most recent data. In one embodiment, such message flow control throttling policy might be defined globally for all channels between a given API and their MAs, and configured from the P&M system as a conflated quality of service. This QoS will apply to all applications subscribing to the conflated QoS. In another embodiment, this throttling policy might be user-defined via an API function call from the application, providing some flexibility. In that particular case, the API communication engine communicates the throttling policy when establishing the channel with the MA. The channel configuration parameters are negotiated between the API communication engine and the MA during that phase.

Note that when this user-defined throttling policy is implemented at the subscription-level rather than at the message-level, an application can define the policy when subscribing to a given topic. The subscription-based throttling policy is then added to the channel configuration for this particular subscription.

The API communication engine can be configured to provide value-added message processing; and so can the MA to which the API is connected. For value added message processing, an application might subscribe to an inline value-added message processing service for a given subscription or a set of subscriptions. This service will then be performed or applied to the subscribed message streams. Moreover, an application can register some pseudo code using a high-level message processing language for referencing fields in the message (e.g., NEWFIELD=(FIELD(N)+FIELD(M))/2, which defines the creation of a new field at the end of the message with a value equal to the arithmetic average of fields N and M). These value-added message processing services might require service-specific states to be maintained and updated as new message are processed. These states would be defined the same way that field are defined and they would be reused in the pseudo code (e.g., STATE(0)+=FIELD(N), which means that state number 0 is the cumulative sum of FIELD(N)). Such services can be defined by default in the system and the applications just need to enable them when subscribing to a specific topic, or they can be user-defined. Either way, such inline value-added message processing services can be performed by the API communication engine or the MA connected to that API.

Similar to the inline added-value message processing services, content-based access control list (ACL) can be deployed on the API communication engine or the MA, or both depending on the implementation. Assuming for instance that a stock trader may be interested in messages with the price quotes of IBM but only when IBM price is above $50, and otherwise it prefers to drop all messages that have a price quote below that value. For this the API (or MA) is further able to define a content-based ACL and the application will define a subscription-based ACL. A subscription-based ACL could be the combination of an ACL condition, expressed using the fields in the message, and an ACL action, expressed in the form of REJECT, ACCEPT, LOG, or another suitable way. An example of such ACL is: (FIELD(n)<VALUE, ACCEPT, REJECT|LOG).

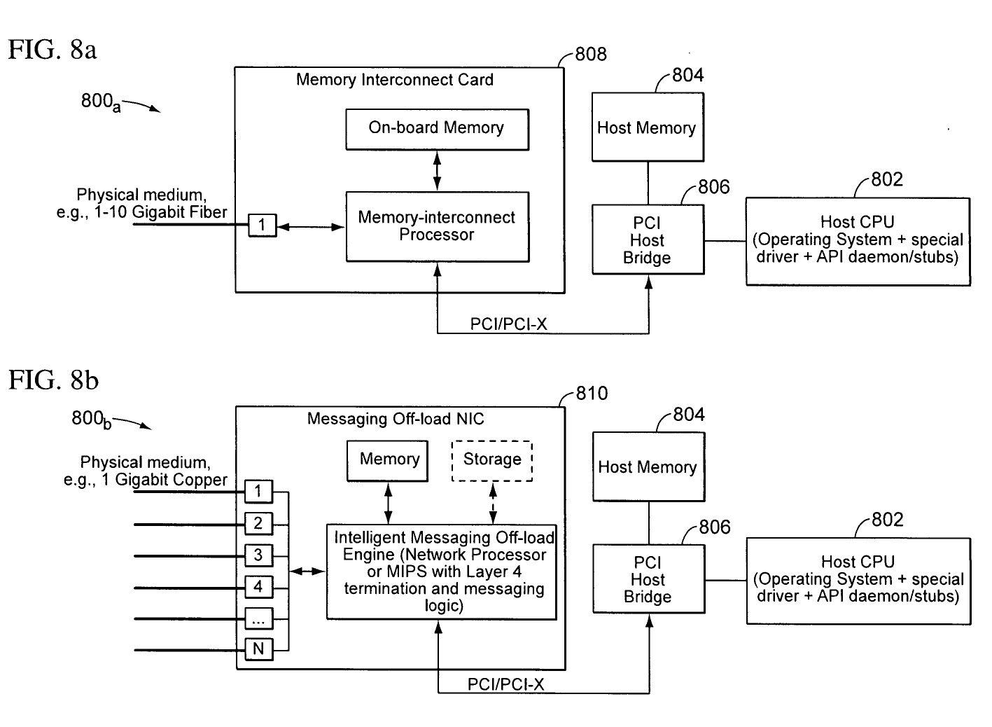

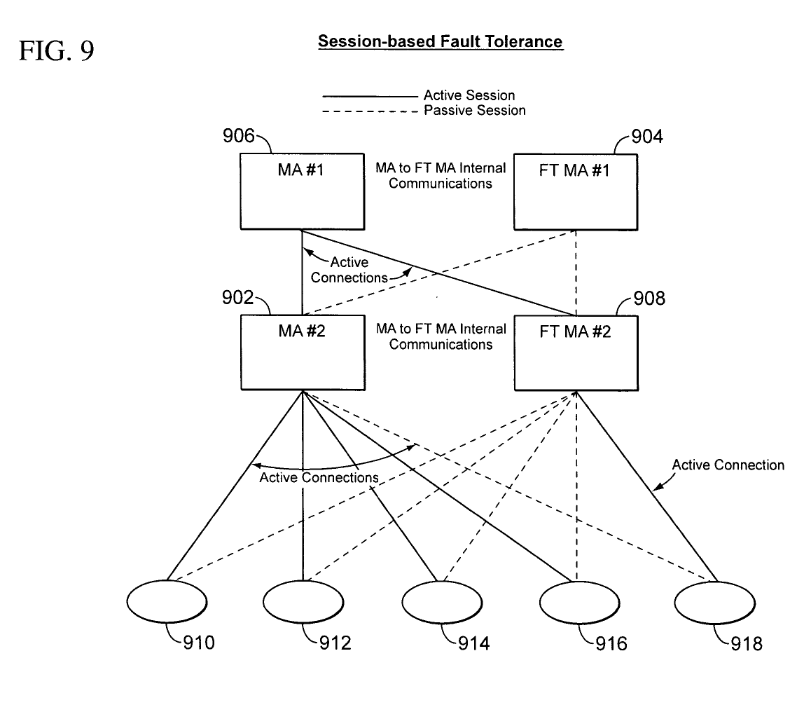

For further improving efficiency, the API communication engine can be configured to off-load some of the message processing to an intelligent messaging network interface card (NIC). This intelligent messaging NIC is provided for bypassing the networking I/O by performing the full network stack in hardware, for performing DMA from the I/O card directly into the application memory space and for managing the messaging reliability, including retransmissions and temporary caching. The intelligent messaging NIC can further perform channel management, including message flow control, value-added message processing and content-based ACL, as described above. Two implementations of such intelligent messaging NIC are illustrated in FIGS. 8a and 8b, respectively. FIG. 8a illustrates a memory interconnect card 808 and FIG. 8b illustrates a messaging off-load card 810. Both implementations include a host CPU 802, a host memory 804 and a PCI host bridge 806.

As is well known, reliability, availability and consistency are often necessary in enterprise operations. For this purpose, the publish/subscribe middleware system can be designed for fault tolerance with several of its components being deployed as fault tolerant systems. For instance, MAs can be deployed as fault-tolerant MA pairs, where the first MA is called the primary MA, and the second MA is called the secondary MA or fault-tolerant MA (FT MA). Again, for store and forward operations, the CE (cache engine) can be connected to a primary or secondary core/edge MA. When a primary or secondary MA has an active connection to a CE, it forwards all or a subset of the routed messages to that CE which writes them to a storage area for persistency. For a predetermined period of time, these messages are then available for retransmission upon request.

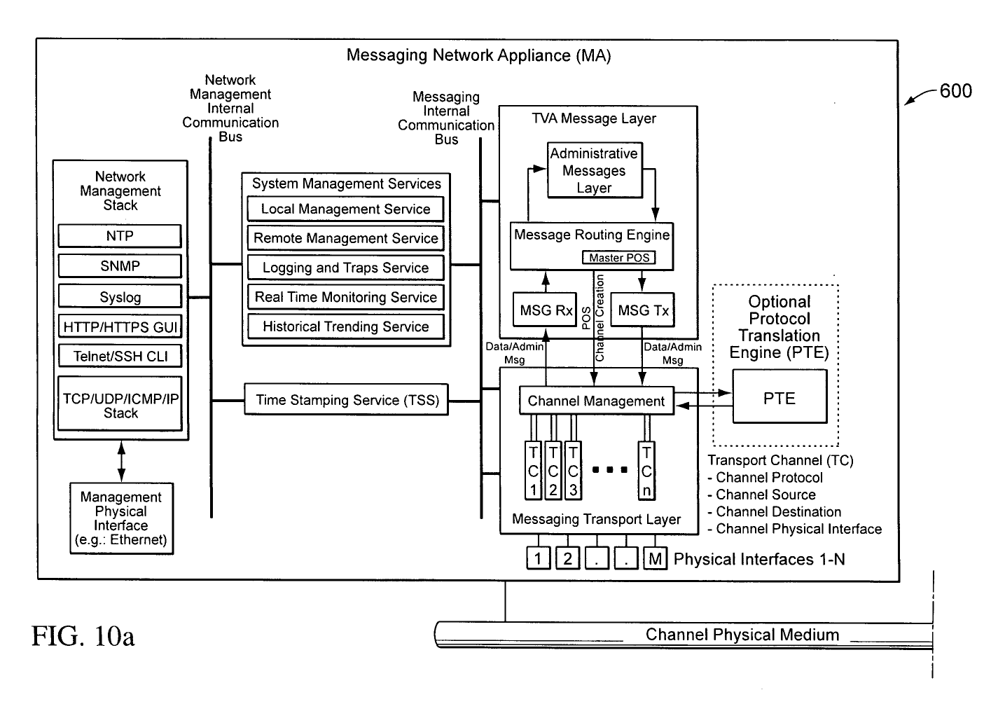

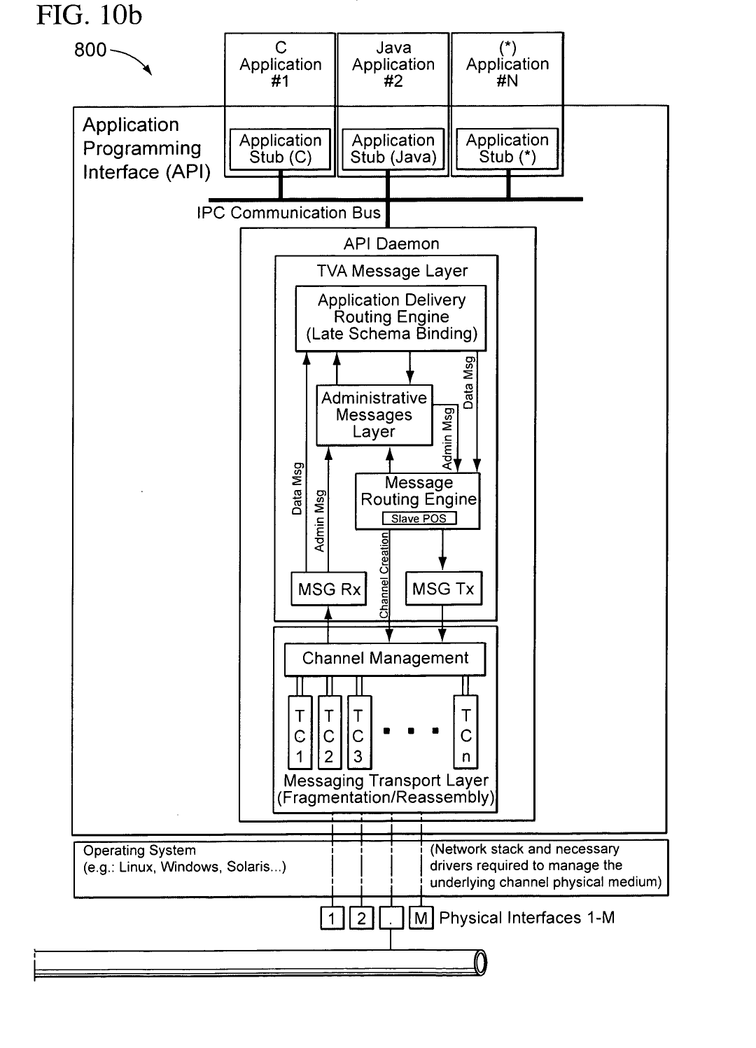

An example of fault tolerant design is shown in FIG. 10. In this example, the system is session-based fault tolerant. Another possible configuration is full failover but in this instance we have chosen session-based fault tolerance. A session is defined as a communication between two MAs or between one MA and an API. A session encompasses the communications between two MAs or between one MA and an API (e.g., 910) and it can be active or passive. If a failure occurs, the MA or the API may decide to switch the session from the primary MA 906 to the secondary MA 908. A failure occurs when a session experiences failures of connectivity and/or system resources such as CPU, memory, interfaces and the like. Connectivity problems are defined in terms of the underlying channel. For instance, an IP-based channel would experience connectivity problems when loss, delay and/or jitter increase abnormally over time. For a memory-based channel, connectivity problems may be defined in terms of memory address collisions or the like. The MA or the API decide to switch a session from the primary MA to the secondary MA whenever this session experiences some connectivity and/or system resource problems.

In one implementation, the primary and secondary MA may be seen as a single MA using some channel-based logic to map logical to physical channel addresses. For instance, for an IP-based channel, the API or the MA could redirect the problematic session towards the secondary MA by updating the ARP cache entry of the MA logical address to point at the physical MAC address of the secondary MA.

Overall, the session-based fault tolerant design has the advantage of not affecting all the sessions when only one or a subset of all the sessions is experiencing problems. That is, when a session experiences some performance issues this session is moved from the primary MA (e.g., 906) to the secondary fault tolerant (FT) MA 908 without affecting the other sessions associated with that primary MA 906. So, for instance, API₁₋₄ are shown still having their respective active sessions with the primary MA 902 (as the active MA), while API₅ has an active session with the FT MA 908.

In communicating with respective MAs the APIs use a physical medium interfaced via one or more commodity or intelligent messaging off-load NIC. FIG. 10 illustrates the interface for communications between the API and the MA.

In sum, the present invention provides a new approach to messaging and more specifically a new publish/subscribe middleware system with an intelligent messaging application programming interface. Although the present invention has been described in considerable detail with reference to certain preferred versions thereof, other versions are possible. Therefore, the spirit and scope of the appended claims should not be limited to the description of the preferred versions contained herein.

What is claimed is:

1. An application programming interface for communications between applications and a publish/subscribe middleware system, comprising:
a communication engine configured to function as a gateway for communications between applications and a publish/subscribe middleware system with the communication engine being operative, transparently to the applications, for using a dynamically selected message transport protocol and for monitoring and dynamically controlling, in real time, transport channel resources and flow;
one or more stubs for communications between the applications and the communication engine; and
a bus for communications between the one or more stubs and the communication engine.

2. An application programming interface as in claim 1, wherein the bus is an inter-process or intra-process communications bus.

3. An application programming interface as in claim 1, with the communication engine being further operative for dynamically adjusting the number of messages packed in a frame.

4. An application programming interface as in claim 1, with the communication engine being further operative for session-based fault tolerance.

5. An application programming interface as in claim 1, with the communication engine being further operative for temporary caching of messages.

6. An application programming interface as in claim 1, with the communication engine being further operative for value-added message processing.

7. An application programming interface as in claim 6, wherein the value-added message processing includes deployment of a content-based access control list with each entry in the list being associated with a an access condition and action.

8. An application programming interface as in claim 1, with the communication engine being further operative for registering with and becoming logically connected to a messaging appliance in the publish/subscribe middleware system.

9. An application programming interface as in claim 8, wherein the registration is a logging request and a subscription is topic-based, where a topic defines a shared-access domain as to which the application programming interface has a publish/subscribe entitlement.

10. An application programming interface as in claim 1, with the communication engine being further operative for late schema binding.

11. An application programming interface as in claim 1, with the communication engine being further operative for partial message publishing.

12. An application programming interface as in claim 1, with the communication engine being further operative for direct memory access to stored messages by the applications.

13. An application programming interface as in claim 1, with the communication engine being further operative for handling bulk messaging.

14. An application programming interface as in claim 12, wherein handling the bulk messaging involves message queuing with a restriction to avoid queue overflow and communication latency.

15. An application programming interface as in claim 1, wherein the real time message transport resources and flow control employs a policy of either identifying and disregarding old messages or blending messages.

16. An application programming interface as in claim 15, wherein the policy is applied globally to all message transport paths associated with the application programming interface.

17. An application programming interface as in claim 15, wherein the policy is user defined.

18. An application programming interface as in claim 15, wherein the policy is defined and implemented at application subscription time.

19. An application programming interface as in claim 1, with the communication engine being further operative for handling messages in raw compressed data format and binding the raw data to its schema.

20. An application programming interface as in claim 6, wherein the value-added message processing is defined during application registration.

21. An application programming interface as in claim 1, with the communication engine being further operative to offload message processing to an interface card.

22. An application programming interface as in claim 1, wherein the publish/subscribe middleware system includes a messaging appliance, and wherein the protocol optimization is distributed between the messaging appliance and the application programming interface in a master-slave-based configuration with the application programming interface being the slave.

23. An application programming interface as in claim 2, wherein the inter-process communications bus, if used, is implemented using sockets or shared memory and the intra-process communications bus, if used, is implemented using a function call.

24. An application programming interface for communications between applications and a publish/subscribe middleware system, comprising:
a communication engine configured to function as a gateway for communications between applications and a publish/subscribe middleware system, the communication engine having logical layers including a message layer and a message transport layer, wherein the message layer includes an application delivery routing engine, an administrative message layer and a message routing engine and wherein the message transport layer includes a channel management portion for controlling transport paths of messages handled by the message layer in real time based on system resources usage;
one or more stubs for communications between the applications and the communication engine; and
a bus for communications between the one or more stubs and the communication engine.

25. An application programming interface as in claim 24, wherein the communication engine is deployed on top of an operating system.

26. An application programming interface as in claim 24, wherein the operating system includes a driver for an interface card through which the channel management portion interfaces with a physical medium for transporting messages to and from the applications.

27. An application programming interface as in claim 26, wherein the interface card is a network interface card operative for memory interconnect or for message processing offloading.

28. An application programming interface as in claim 26, wherein the interface card includes a hardware-based networking I/O (input/output) stack and is operative for direct memory access and caching for transmission.

29. An application programming interface as in claim 24, wherein the message routing engine includes a transport protocol optimization service portion.

30. An application programming interface as in claim 24, wherein the application delivery routing engine is operative for mapping applications to topic subscriptions.

31. An application programming interface as in claim 24, wherein the channel management portion controls a plurality of channels and the application delivery routing engine delivers messages to applications based on the mapping.

32. An application programming interface as in claim 30, wherein the administrative message layer handles administrative messages and the routing and application delivery routing engines handle data messages.

33. An application programming interface as in claim 23, wherein the communication engine and the one or more stubs are compiled and linked to the applications which use the application programming interface for communicating with the publish/subscribe middleware system.

34. An application programming interface as in claim 23, with the communication engine being further operative for late binding schema.

35. An application programming interface as in claim 34, wherein the application delivery routing engine is operative to bind schema to raw message data, thereby allowing the applications to transparently access message information.

36. An application programming interface as in claim 1, further comprising a presentation engine operative to translate between application data format and messaging data schema for ingress and egress messages to and from the applications.
